(19) United States
(12) Patent Application Publication
(10) Pub. No.: US 2017/0189258 A1
(43) Pub. Date: Jul. 6, 2017

(54) WALKER

(71) Applicants: GRACE MILLAY OTT, SPOKANE, WA (US); TERESA L. GALVIN, LATAH, WA (US)

(72) Inventors: GRACE MILLAY OTT, SPOKANE, WA (US); TERESA L. GALVIN, LATAH, WA (US)

(21) Appl. No.: 14/983,955

(22) Filed: Dec. 30, 2015

(51) Int. Cl. A61H 3/04

(52) U.S. Cl. CPC A61H 3/04; A61H 2003/002

(57) ABSTRACT

A walker is described and which includes a movable frame which engages a supporting surface; and an enclosure which is releasably attached to the moveable frame and which depicts an object of interest.

### TECHNICAL FIELD

The present invention relates to a walker, or other ambulatory aid which assists a user in walking across a supporting surface; and more specifically to a walker which has an enclosure or hood which is releasably mounted thereon, and which further provides a means for storing personal effects, as well as allowing the user to personalize or customize the appearance of the walker in a manner not possible, heretofore.

### BACKGROUND OF THE INVENTION

A walker is a medical device which is primarily used by the elderly or other mobility-impaired people who could benefit from some assistance or support in maintaining their balance or stability while walking or standing. Typically, a standard walker has a frame with four legs, and which extends to a height of about the waist or hips of the user employing same. The top of the frame of the walker typically lies in a substantially horizontal plane, and during use is gripped by the hands of the user. The user of the walker, at least in part, supports his or her body weight through their arms, and which, in turn, rest upon, and are supported by the walker. Depending upon the walking ability of the person using the walker, the front legs of the walker may, or may not be equipped with wheels; and the rear legs of the walker can have caster-type wheels or glides of various styles, and which rollably or slideably engage a supporting surface or floor so as to allow the frame of the walker to move along the supporting surface.

Various devices have been manufactured through the years, and which have been used in combination with a walker, and which further assist the user in employing the walker in a more effective manner based upon the environment where the user finds themselves. For example, much effort has been expended on making such walkers lightweight, compact, foldable, less tippable, and more comfortable to sit on when a user becomes fatigued. Additionally, efforts have been made, as of late, to provide walkers with improved brakes and selectively adjustable hand grips so that a user can maintain a more erect posture while using the walker, as opposed to a hunched-over posture which is often observed when individuals use these devices.

Notwithstanding these efforts, the walkers that are presently commercially available are somewhat box-like in their shape and often take on the appearance of a rather sophisticated mechanical, and confusingly complex medical ambulatory device.

The “baby boomer” generation is quickly entering retirement, Many “baby boomers” are now needing such walkers due to various health issues which have arisen in their later years such as failing joints, and/or the onset of Parkinson's disease, and the like. The current generation of aging users for walkers, to some degree, still wish to maintain, as long as possible, a youthful appearance, and further desire to be meaningfully engaged by their friends, families, and society in general, Many retirees, and those having various health concerns, are now being treated and sometimes reside in long-term care, or assisted living facilities. These facilities have an increasingly greater selection of physical activities, physical therapy and other health maintenance programs which typically encourage their residents to maintain their physical health through assorted activities including walking, and other events which will improve their overall quality of life.

While some users of the aforementioned commercially available walkers are truly in need of the extra assistance provided by the walker, it is also clearly the case that many users do not like the perceived stigma which is often associated or attached with the use of such devices, and have sought after an effective means of minimizing or substantially downplaying the health issues which have led to, or are associated with the use of the walker with family, friends, business associates, neighbors, and the like. A walker which avoids these and other perceived problems associated with the use of such devices, and other ambulatory aids, is the subject matter of the present invention.

### SUMMARY OF THE INVENTION

A principal aspect of the present invention relates to a walker which includes a frame for supporting, at least in part, a user's weight as the user walks across a supporting surface, and wherein the frame has a forward facing portion, a rearward facing portion, and laterally disposed, and spaced hand grips which are grasped by the user when the walker is being utilized; and an enclosure which is releasably mounted on the forward facing portion of the frame, and which further defines an internal cavity which is accessible from the rearward facing portion of the frame, and wherein the enclosure has an exterior facing surface which depicts an object of interest which is selected by the user.

### BRIEF DESCRIPTION OF THE DRAWINGS

Preferred embodiments of the invention are described below h reference to the following accompanying drawings.

FIG. 1 is a perspective, side elevation view of the walker of the present invention.

FIG. 2 is a transverse, vertical, sectional view taken from a position along the line 2-2 of FIG. 1.

FIG. 3 is a transverse, vertical sectional view of a second form of the invention, and which is taken from a position along line 2-2 of FIG. 1.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

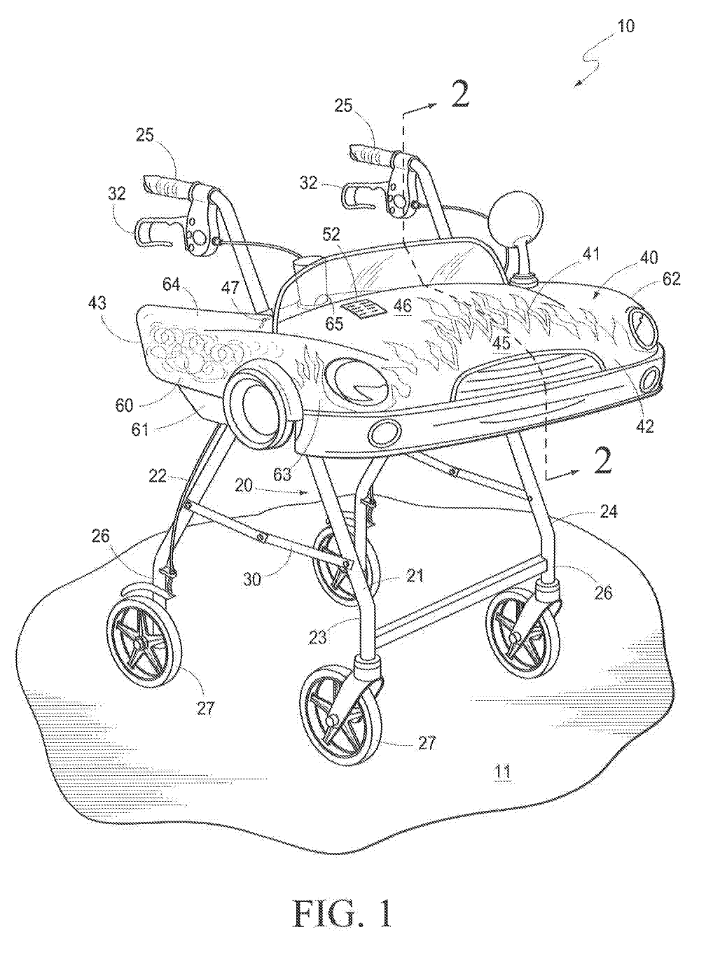

The walker of the present invention is generally indicated by the number 10 in FIGS. 1, 2, and 3 respectively. The walker 10 operates in a manner which is well understood in the art, and is useful for enabling or permitting a mobility-impaired patient, or user, not shown, to move across an underlying supporting surface or floor 11, and support a portion of the user's weight so as to provide enhanced balance, mobility, and security for the user or patient who has walking, standing or balance difficulties. As seen in the several views, the walker 10 includes a frame 20 which has a forward facing portion 21, and an opposite, rearward facing portion 22. Still further the frame has left and right laterally disposed sides 23 and 24, respectively. As further seen in the drawings, the frame 20 includes spaced, laterally disposed handgrips 25 which are engaged by the hands of the user, not shown, and upon which a portion of the user's weight is transferred in order to provide the necessary balance and stability for the user as they walk across the underlying supporting surface 11. As seen in the drawings, the frame 20 has a supporting surface engagement end 26. As seen in FIG. 1, and in one possible form of the invention, the supporting surface engagement end 26 mounts a multiplicity of wheels 27, and which enable the frame 20 to easily roll across the supporting surface 11. In another possible form of the invention the supporting surface engagement end 26 may include at least two gliding members (not shown), and which further slideably engage the supporting surface 11. In another possible form of the invention, the supporting surface engagement end 26 may be a combination of both wheels and gliders. The selection of the aforementioned structures are based upon the walking and/or balance skills that the user or patient has, and the typical supporting surface 11 over which the walker must move (hard surface, carpeted surface, etc.).

The walker 10 has a folding mechanism which is generally indicated by the numeral 30, and which further allows the walker to be folded or collapsed so that it may be conveniently transported or stored. The folding mechanism 30 is of traditional design, and further discussion regarding the operation of this structure is unwarranted. In one form of the present invention, the walker includes a foldable seat (not shown). Further the walker 10 may be fabricated so as to not have a foldable seat. The presence or absence of the foldable seat is not germane to the teachings of the present invention. The foldable seat 30 which is well known, is operable, in a first, stored position, to allow the walker 10 to be folded or collapsed for easy transport; and in a second, deployed position the foldable seat can be moved to a substantially horizontal orientation. The user may then sit upon the seat to rest when they are fatigued. The walker as illustrated further includes a foldable, and padded backrest 31, and which supports the back of the user when they are seated on the foldable seat (not shown). The walker 10 of the present invention further includes a pair of traditional, hand-operated brakes which are generally indicated by the numeral 32. The brakes allow the walker to be substantially immobilized on the supporting surface 11 when a user, for example, is resting or further needs the walker to be maintained in a given location so that they may sit on, or arise from a nearby chair, bench, bed or the like, with safety.

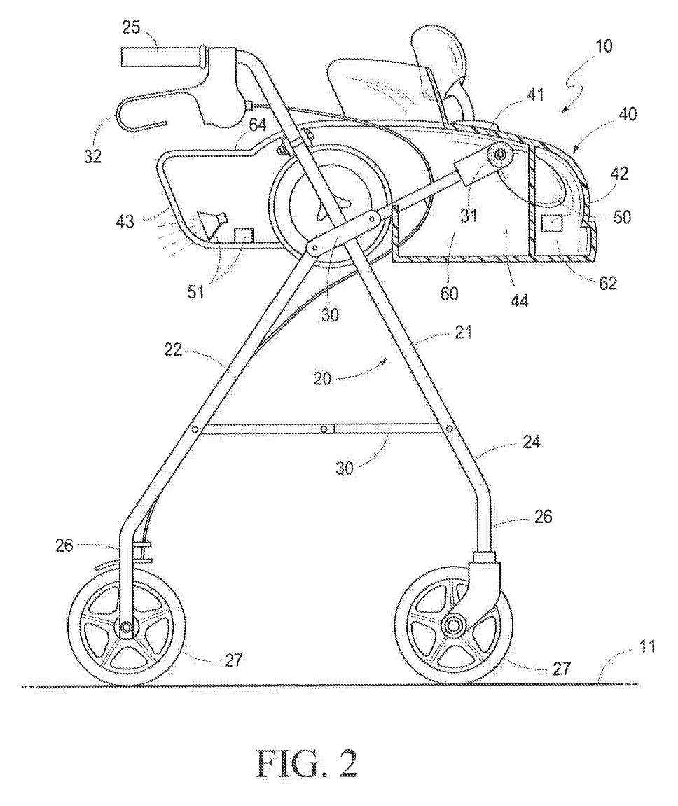

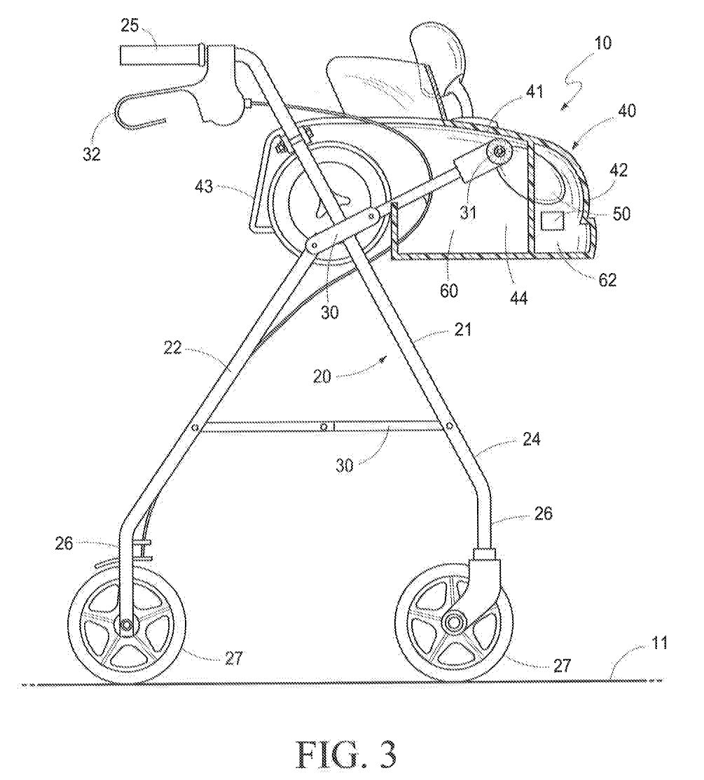

The present invention 10 includes an enclosure, shroud or hood 40. The enclosure which is fabricated from a light-weight, moldable substance such as a synthetic polymer has a main body 41 which has a first or forward facing portion 42, and a second or rearward facing portion 43. Still further the main body 41 defines an internal cavity 44 which is sized so as to be able to receive the personal effects of the user who is utilizing the walker 10. The internal cavity 44 is typically accessible from the rearward facing portion 22 of the frame 20. Still further the enclosure 40 has an exterior facing surface 45 which depicts an object of interest 46 which is pleasing or of interest to the user. The depicted object of interest 46 is selected from the group which includes alpha-numeric characters; sports teams logos; college or military affiliations; an image of an overland vehicle; an image of one or more animals; an image of a real or imaginary character or other being; an image of a real or imaginary location; and/or an image of a real or imaginary structure, to name but a few. As depicted in the drawings, the enclosure is shaped to appear as an automobile which has a flame-like design shown on the forward facing portion 42. Depending upon the desires of the user, the depicted object of interest may be illustrated in a three dimensional fashion such as shown in FIG. 1. The enclosure 40 is releasably mounted on the frame 20 by at least one fastener 47, and which can typically be easily and quickly manipulated by the hand of the user, not shown. In one form of the invention, the fastener may be a screw-threadable type toggle-type fastener 47 as seen in FIG. 1. In still another form of the invention the fastener may include a hook and loop type fastener which temporarily secures the enclosure 40 in the appropriate position or orientation on the frame 20. Other styles of fasteners may be substituted for the aforementioned fasteners without deviating from the teachings of the present invention, The enclosure 40 may further include side portions which are generally indicated by the numeral 60. The respective side portions include a first side portion 61, which is positioned on the right hand side of the frame 20, and a second side portion 62, and which is positioned and otherwise releasably secured in partial covering relation relative to the right side of the frame 20. The first and second side portions 61 and 62 have an exterior facing surface 63 which, again, depicts, at least in part, a portion of an object of interest, and which is generally indicated by the numeral 64. The depicted object of interest 64 may be similar to, or compliment the depicted object of interest 46 as seen on the enclosure 40, or may be a continuation of same. As best seen in FIG. 3, the respective side portions may be shortened, in length, so as to accommodate walkers having different dimensions or designs. In one possible form of the invention the side portions 61 and 62 may be made rigidly integral with the enclosure 40 (FIG. 1). In another form of the invention the respective side portions could be moveably joined to the enclosure by a hinge (not shown), and which would enable the respective side portions 61 and 62 to be moved to a collapsed or folded orientation relative to the enclosure 40 so as to allow the enclosure to be easily stored or transported after it is removed from the walker. A vessel holder 65 may be formed in either of the side portions 60, or enclosure 40, and may be useful for holding a drinking vessel of various designs; an oxygen bottle or other vessels carrying liquid or gaseous fluids which are useful to the user of the walker 10. Further the internal cavity 44 may be sized so as to receive a supplemental oxygen bottle so that it cannot be seen by others. As further seen in FIGS. 2 and 3, the foldable backrest 31 is received in the internal cavity 44, and supports, at least in part, a portion of the weight of the hood or enclosure 40. Of course, other medical monitoring equipment could be placed in the internal cavity 44, and out of the view of others. As depicted, the enclosure 40 may be fabricated in a manner where it is opaque, or in the alternative, the enclosure 40 may be fabricated in a manner where it is at least partially translucent. Still further, and yet in another possible form of the invention, the enclosure 40 may be fabricated in a manner so as support, or otherwise mount various battery powered lights 50 on the enclosure 40. In one possible form of the invention, the enclosure 40 could mount or deploy a small and inconspicuous solar panel 52 (FIG. 1), and which could be employed to recharge any battery used to energize the lights 50 on the enclosure 40. These battery powered lights 50 may be arranged in such a manner that they be selectively energized by the user so as to provide a pleasing appearance for the walker 10, and even provide a degree of safety for the user of the walker when the walker is being utilized in low ambient lighting conditions such as in dark parking lots, in street crosswalks, and the like. Similarly, the enclosure could be equipped with a battery powered sound assembly, or alarm 51 (FIG. 2), and which could be used by a patient or user in the event the user, or the patient, needs to call for assistance in the event that they cannot walk any further, or have some other health or safety need. The enclosure 40 can be sized so as to extend nearly to the supporting surface 11, or only cover a portion of the forward facing portion 21 of the frame 20. As seen in FIG. 2, and as noted above, a portion of the walker 10 supports the enclosure 40 in an appropriate orientation, and further acts as a back support for the user when the person is utilizing the seat (not shown). The enclosure 40 may further include other storage regions or formed pockets, and into which other devices may be inserted like cellular telephones, hand-held GPS units, and transponder/locator units. GPS units could be employed by a user or patient, for example, to find their way back to an automobile, for example, which is parked in a large parking lot, after they have forgotten where they parked. A transponder unit could, for example, permit a family member, healthcare worker and/or law enforcement personnel to locate the walker (and the user or patient) should the user thereof become inadvertently disoriented or forgetful, and walk away from a healthcare facility or their residence.

### OPERATION

The operation of the described embodiments, of the present invention are believed to be readily apparent, and are briefly summarized at this point. In its broadest aspect, the present invention relates to a walker 10 which includes a frame 20 for supporting, at least in part, a users weight as the user walks across a supporting surface 11. The frame 20 has a forward facing portion 21; a rearward facing portion 22; and laterally disposed, and spaced grips 25 which are grasped by the user when the walker is being utilized. The walker 10 further includes an enclosure 40 which is releasably mounted on the forward facing portion 21, of the frame 20, and which further defines an internal cavity 44 which is accessible from the rearward facing portion 22 of the frame 20. The enclosure 40 has an exterior facing surface 45 which depicts an object of interest 46.

In the arrangement as seen in FIG. 1, the frame 20 further mounts at least a pair of spaced wheels 27 which rollably engage the supporting surface 11, and over which the user walks. As earlier discussed, the enclosure 40 is releasably mounted on the frame 20 by at least one fastener 47, and which can be easily manipulated by the hand of the user. This permits the enclosure 40 to be easily, and readily removed from the frame 20 so as to allow the frame 20 to be folded or collapsed for storage or transportation. As noted earlier in the specification, the depicted object of interest 46 is selected from a wide group which include such objects of interest as alpha-numeric characters; a sport team's logo; college or military affiliation; an image of an overland vehicle; an image of one or more animals; an mage of a real or imaginary character or other being; an image of a real or imaginary location; an image of a real or imaginary structure, and other similar objects. As noted above, the frame 20 has opposite, laterally disposed sides 23 and 24, respectively. The enclosure 20 further comprises side portions 60 which cover, at least in part, a portion of the respective lateral sides 23 and 24 of the frame 20. The enclosure 20 is made from a lightweight moldable substrate, and can depict objects of interest 46 in three dimensions, and further provides an internal cavity 44 which is sized so as to be able to receive, enclose and secure the personal effects of the user as they are utilizing the walker 10. The internal cavity is accessible from the rearward facing portion 22 of the frame 20.

Therefore, the walker 10 of the present invention has many advantages over the prior art devices and practices, and further provides a user with numerous options regarding how they accessorize, customize or otherwise visually present their walker 10 to their family, friends and the general community. The walker 10, as described herein is reliable, and provides support and walking assistance for a user or patient needing such assistance, and further allows a user an increased level of personal satisfaction by allowing them to customize or otherwise accessorize their walker for their own personal satisfaction, and to detract or minimize, to the degree possible, any stigma which might be associated with the use of this type of ambulatory assistance device.

In compliance with the statute, the invention has been described in language more or less specific as to structural and methodical features. It is to be understood, however, that the invention is not limited to the specific features shown and described, since the means herein disclosed comprise the preferred forms of putting the invention into effect. The invention is, therefore, claimed in any of its forms or modifications within the proper scope of the appended claims appropriately interpreted in accordance with the doctrine of equivalence.

We claim:

1. A walker, comprising:
a frame for supporting, at least in part, a user's weight as the user walks across a supporting surface, and wherein the frame has a forward facing portion, a reward facing portion, and laterally disposed, and spaced hand-grips which are grasped by the user when the walker is being utilized; and
an enclosure which is releasably mounted on the forward facing portion of the frame, and which further defines an internal cavity which is accessible from the rearward facing portion of the frame, and wherein the enclosure has an exterior facing surface which depicts an object of interest.

2. A walker as claimed in claim 1, and wherein the frame further mounts at least a pair of spaced wheels which rollably engage the supporting surface over which the user walks.

3. A walker as claimed in claim 1, and wherein the frame includes at least two gliding members which slideably engage the supporting surface.

4. A walker as claimed in claim 1, and wherein the frame is foldable for storage.

5. A walker as claimed in claim 1, and wherein the frame further includes a seat for use by the user thereof.

6. A walker as claimed in claim 1, and wherein the enclosure is releasably mounted on the frame by at least one fastener, and which can be manipulated by a hand of the user.

7. A walker as claimed in claim 6, and wherein the fastener is a screw-threadable fastener.

8. A walker as claimed in claim 6, and wherein the fastener is a hook and loop-type fastener.

9. A walker as claimed in claim 1, and wherein the object of interest is selected from the group which includes alpha-numeric characters; a sports team's logo; a college or military affiliation; an image of an overland vehicle; an image of one or more animals; an image of a real or imaginary character or other being; an image of a real or imaginary location; an image of a real or imaginary structure.

10. A walker as claimed in claim 9, and wherein the depiction of the object appears in three dimensions.

11. A walker as claimed in claim 1, and wherein the enclosure is fabricated from a thermo-moldable synthetic polymer.

12. A walker as claimed in claim 1, and wherein the frame has opposite laterally disposed sides, and wherein the enclosure further comprises side portions which cover, at least in part, a portion of the respective lateral sides of the frame.

13. A walker as claimed in claim 12, and wherein the side portions have an exterior facing surface which depicts, at least in part, a portion of an object of interest.

14. A claim as claimed in claim 12, and wherein the side portions are releasably mounted on the frame by a hand-manipulatable fastener.

15. A walker as claimed in claim 1, and wherein the internal cavity of the enclosure is sized so as to store the users personal belongings or effects.

16. A walker as claimed in claim 1, and wherein the enclosure defines at least one drink holder.

17. A walker as claimed in claim 1, and wherein the enclosure is opaque.

18. A walker as claimed in claim 1, and wherein the enclosure is at least partially translucent.

19. A walker as claimed in claim 1, and wherein the enclosure mounts a selectively energizable light.

20. A walker as claimed in claim 1, and wherein the enclosure mounts a selective energizable and audible alarm.
